(19) United States
(12) Patent Application Publication
(10) Pub. No.: US 2008/0292210 A1
(43) Pub. Date: Nov. 27, 2008

(54) Method and device for converting and displaying web image data of different formats on display of electronic device

(76) Inventor: Chiu-Fu Chen, Sanchong City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/153,627

(22) Filed: May 22, 2008

(30) Foreign Application Priority Data
May 25, 2007 (CN) 200710028198.4

(51) Int. Cl. G06K 9/36

(52) U.S. Cl. 382/276

(57) ABSTRACT

Disclosed are a method and a device for converting and displaying web image data of different formats on a display of an electronic device. An image format conversion module is linked to an internet and receives and converts web image data of different formats transmitted from a remote internet server at a predetermined web site on the internet into an image in a standard image output format. The image that is converted into the standard image output format is then transferred to an electronic device for displaying the image of the standard image output format.

### FIELD OF THE INVENTION

The present invention generally relates to a web image data converting method and device, and in particular to a device and a method that convert different formatted web image into a universal standard format image and displays the image on a display of an electronic device.

### BACKGROUND OF THE INVENTION

The technology today changes with each passing day. Today, televisions can link up to a remote internet server through the internet by using a TV set-top box. This allows the television to display web images of different formats received from the remote internet server on a designated internet location or wet site.

The TV set-top box receives different format image data from the remote internet server on a designated internet location, and uses an image processing unit and various image format decoders to decode and process the received web image data. After decoding and processing, the image data is displayed on the TV to allow users to view web image data in different formats received from the remote internet server on the designated internet location.

In the conventional technology, most of the TV set-up boxes must be equipped with a very powerful image processing unit and various decoders associated with different image formats in order properly process and decode the web image data received from a remote internet server for further display of the different formatted image data on the TV. However, the powerful image processing unit and the various image format decoders cause the cost of the TV set-up box to rise accordingly.

For a television to operate in coordination with the TV set-up box, it must consider whether it can correctly display the different formatted image data. Thus, this kind of conventional TV set-up box costs more and cannot promise to correctly display the different format image data. These drawbacks cause inconvenience and cost problems

### SUMMARY OF THE INVENTION

Accordingly, an objective of the present invention is to provide a method and a device for converting and displaying web image data of different formats on a display of an electronic device, which employs an image format conversion module to convert image data of various known formats into a universal standard image output format.

Another objective of the present invention is to provide a method applicable to the internet for converting and displaying web image data transmitted through the internet, wherein an image format conversion module is employed to convert the web image data of various formats received from a remote internet server at a predetermined web site into images of a universal standard image output format, and displays the image on a display of an electronic device.

To overcome the drawbacks of the conventional technology, the present invention provides a method and a device for converting and displaying web image data of different picture formats on a display of an electronic device, wherein the electronic device is linked up to a remote internet server at a predetermined web site on the internet through an image format conversion module and the internet.

The image format conversion module comprises an image processing unit, an image format database, and a standard image output format interface, wherein the image processing unit receives the web image data from the remote internet server and the image format database contains a plurality of predefined image formats and the standard image output format.

When the image processing unit receives the web image data, the image processing unit compares the received web image data with the image formats defined in the image format database and converts the received web image data into an image of the standard image output format that is recognizable by the electronic device. The image of the standard image output format is then transmitted to the electronic device through the standard image output format interface and displayed on the display device of the electronic device.

In a preferred embodiment of the present invention, the standard image output format interface of the image format conversion module is further connected to a wireless transmission/receiving circuit and the electronic device also includes a wireless transmission/receiving circuit, allowing transmission of image data and signal between the image format conversion module and the electronic device.

In comparison to the technology on hand, the present invention uses an image format conversion module to receive web image data of various formats from a remote internet server at a predetermined web site and converts the web image data into an image of a standard image output format and displays the image on a display of an electronic device. Thus, the present invention can overcome the drawback of high cost of the conventional TV set-top box due to the powerful image processing unit and the multiple image format decoders for displaying web image data of various formats from the remote internet server at a predetermined web site on TV connected to the TV set-top box.

Further, besides being effective in reducing the costs, the present invention also allows different types of electronic devices, such as PDAs and cell phones, to display the web image data of different formats from the remote internet server, and exhibits improved business value.

The preferred embodiment of the present invention will be described with reference the attached drawings, in which:

### BRIEF DESCRIPTION OF THE DRAWINGS

FIG. 1 schematically shows a converter for converting web image data of different formats in accordance with a first preferred embodiment of the present invention;

FIG. 2 is a system block diagram of the converter in accordance with the first preferred embodiment of the present invention;

FIG. 3 shows a flow chart of the method for converting and displaying web image data of different formats on a display of an electronic device in accordance with the first embodiment of the present invention;

FIG. 4 schematically shows a converter for converting web image data of different formats in accordance with a second preferred embodiment of the present invention;

FIG. 5 is a system block diagram of the converter in accordance with the second preferred embodiment of the present invention; and

FIG. 6 shows a flow chart of the method for converting and displaying web image data of different formats on a display of an electronic device in accordance with the second embodiment of the present invention.

### DETAILED DESCRIPTION OF THE PREFERRED EMBODIMENTS

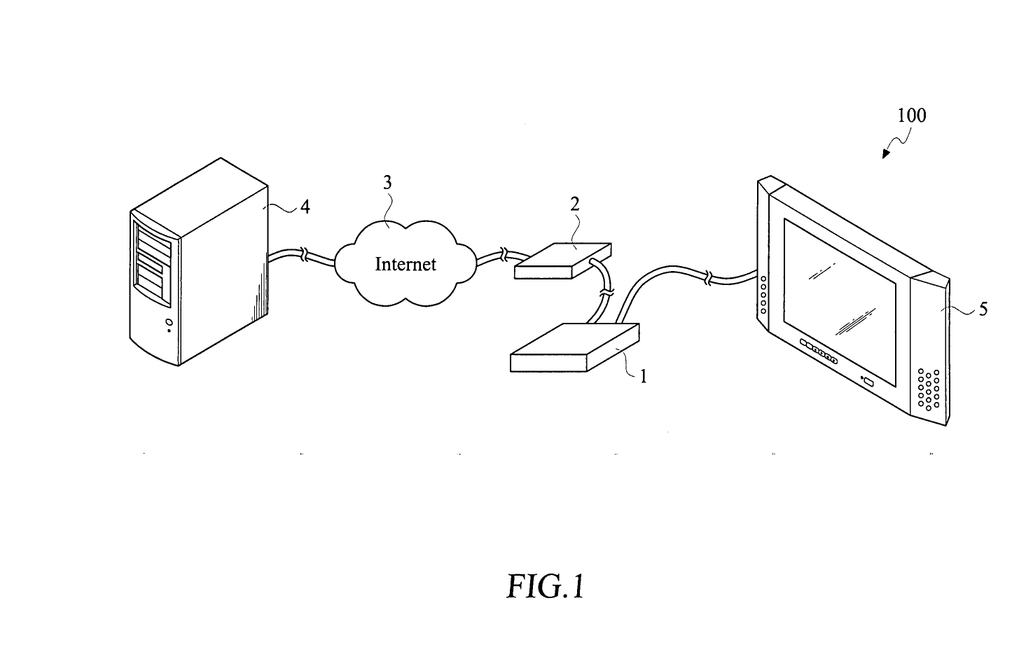

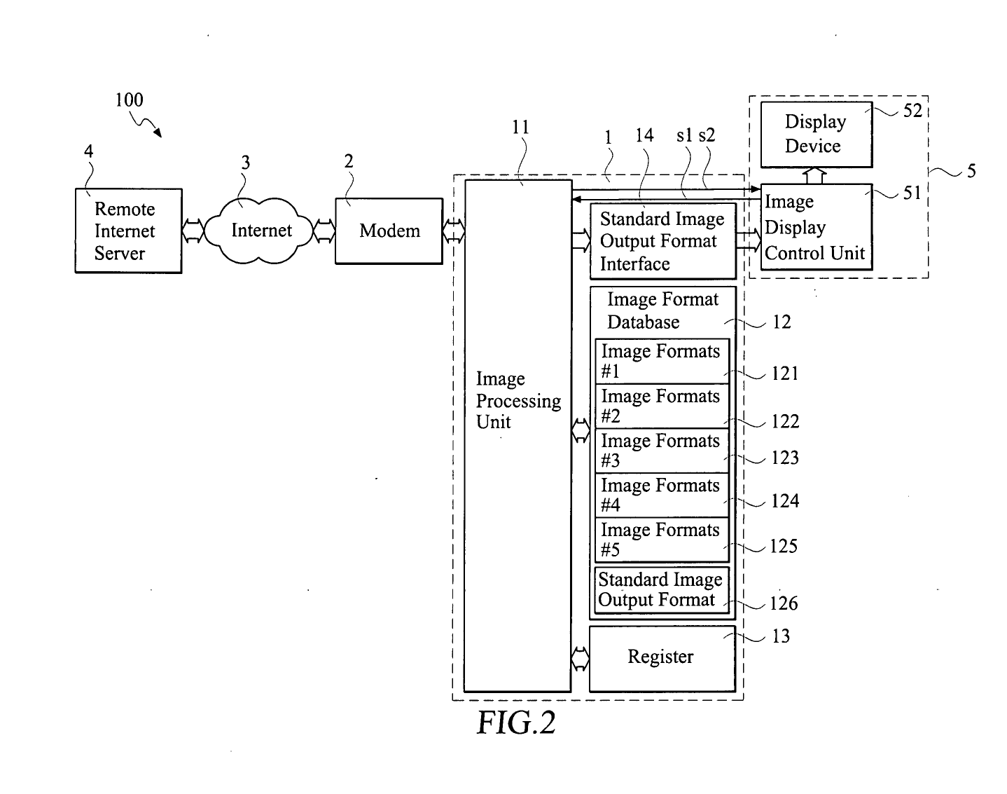

With reference to the drawings and in particular to FIG. 1, which schematically illustrates a converter constructed in accordance with a first embodiment of the present invention for converting web image of different image formats, and FIG. 2, which illustrates a block diagram of the converter of the first embodiment of the present invention, the converter, which is broadly designated at 100, comprises an image format conversion module 1, which is linked up to a remote internet server 4 through a modem 2 and internet 3. The image format conversion module 1 comprises an image processing unit 11, an image format database 12, a register 13, and a standard image output format interface 14. The image processing unit 11 receives web image data of different formats from the remote internet server 4, and converts the web image data into images of the standard image output format.

The image format database 12 is connected to the image processing unit 11, and includes a plurality of pre-defined image formats 121, 122, . . . , 125 and the standard image output format.

The register 13 is connected to the image processing unit 11, and is used to store the web image data received by the image processing unit 11. The standard image output format interface 14 is connected to the image processing unit 11, and is used to transfer the images outputted by the standard image output format interface to an electronic device 5.

The electronic device 5 is linked up to the remote internet server through the image format conversion module 1, the modem 2, and the internet 3. The electronic device 5 includes an image display control unit 51 and a display device 52. The image display control unit 51 is connected to the standard image output format interface 14 of the image format conversion module 1 in order to receive the image data in the standard image output format. The display device 52 is connected to the image display control unit 51 in order to display the image of the standard image output format.

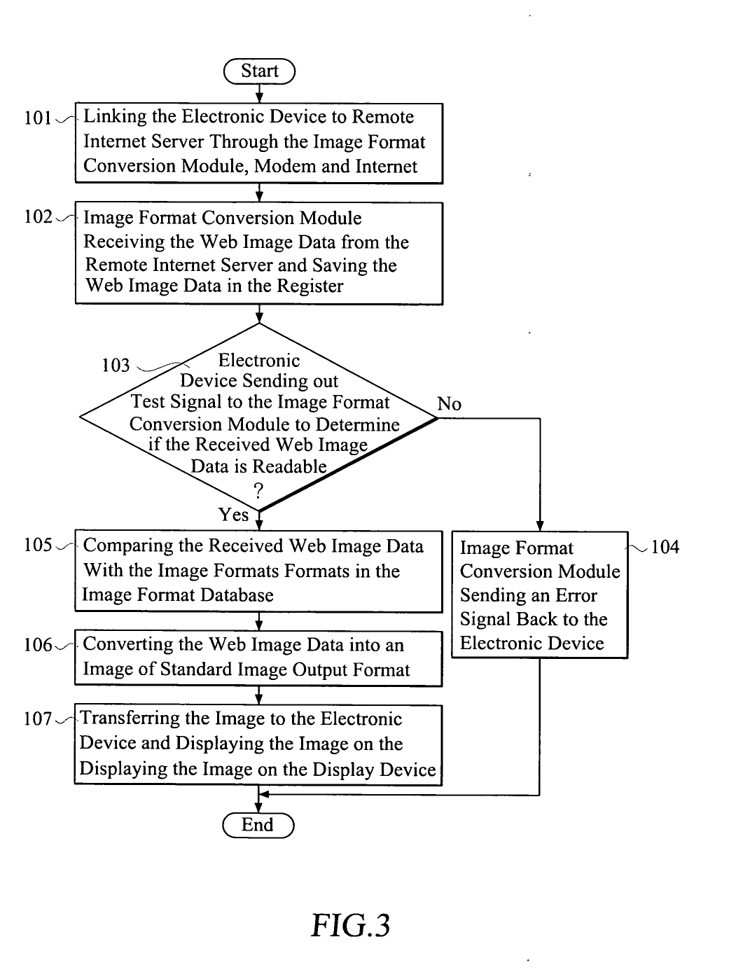

Referring to FIG. 3, a flow chart of the method for converting and displaying web image data of different formats on a display device of an electronic device in accordance with the first embodiment of the present invention is shown. As shown, when a user wants to see a web image from the remote internet server 4 at a selected web site in the internet, the electronic device 5 uses the image format conversion module 1, the modem 2, and the internet 3 to link up to the remote internet server 4 (step 101). The image format conversion module 1 receives web image data from the remote internet server 4 and saves the web image data in the register 13 (step 102).

The electronic device 5 sends out a test signal si to the image format conversion module 1 to determine whether the web image data received from the remote internet server 4 at the selected web site is of a format belonging to the plurality of image formats 121, 122, . . . , 125 predefined in the image format conversion module 1 and further determining whether the received web image data is readable (step 103).

If the received web image data is unreadable, the image format conversion module 1 feeds an error signal s2 back to the electronic device 5, to inform the user that the web image from the remote internet server 4 at the selected web site is unreadable (step 104).

If the received web image data is readable, the received web image data is compared with the image formats 121, 122, . . . , 125 defined in the image format database 12 (step 105), and converts the received web image data into an image of the standard image output format (step 106).

The image that is converted to the standard image output format is then transferred to the image display control unit 51 of the electronic device 5 through the standard image output format interface 14, and is displayed on the display device 52 (step 107), to allow the user to observe the web image data from the remote internet server 4 at the selected web site.

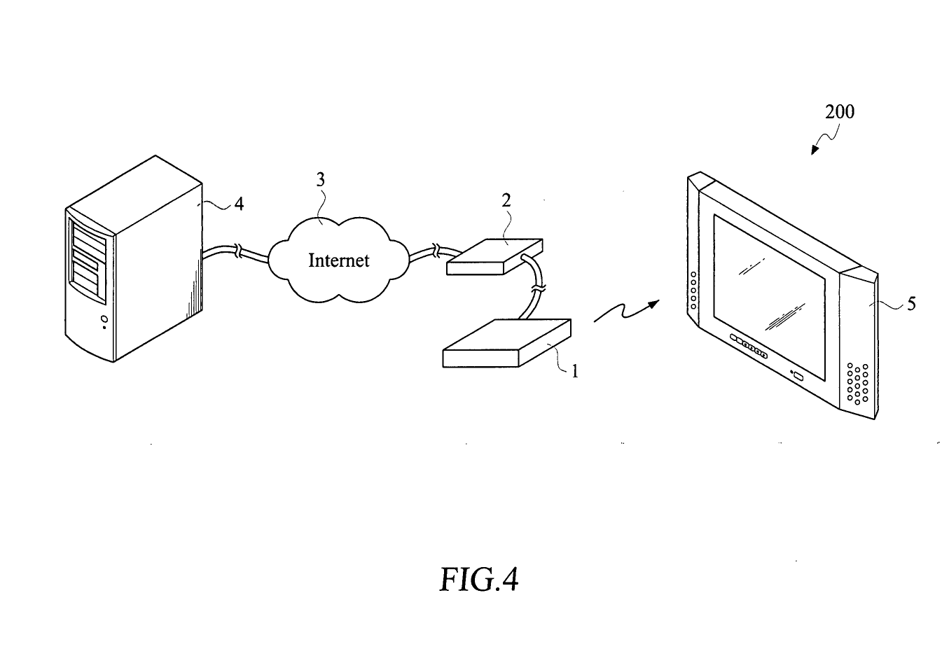

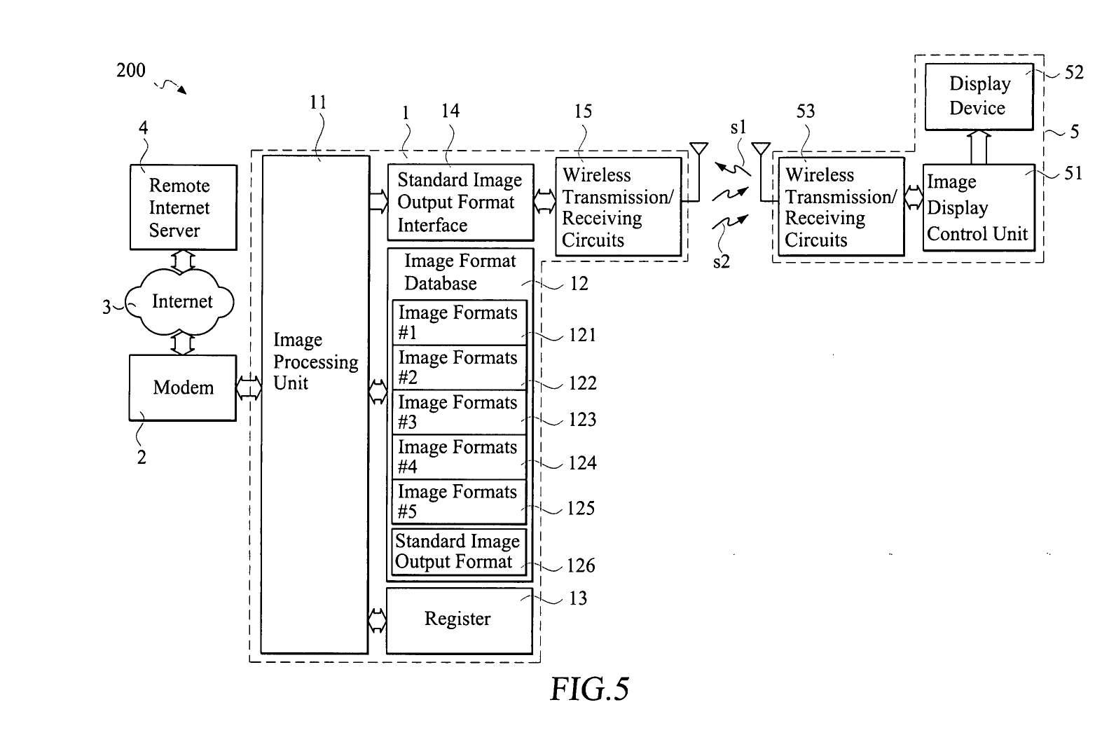

With reference to FIG. 4, a converter for converting web image of different image formats in accordance with a second preferred embodiment of the present invention is illustrated. Also, FIG. 5 shows a system block diagram of the converter of the second preferred embodiment of the present invention. The converter in accordance with the second embodiment, which is broadly designated at 200, is constructed to be substantially identical to the converter 100 with reference to the first embodiment and thus the same element is designated with the same reference numeral. The difference between the converter 100 of the first embodiment and the converter 200 of the second preferred embodiment resides in that, in the converter 200 of the second embodiment, the image format conversion module 1 is further implemented with a wireless transmission/receiving circuit 15 connected to the standard image output format interface 14, and associated therewith, the electronic device 5 includes a wireless transmission/receiving circuit 53 connected to the image display control unit 51. These wireless transmission/receiving circuits 15, 53 allow transmission of the images of the standard image output format, the test signal s1, and the error signal s2 between the image format conversion module 1 and the electronic device 5.

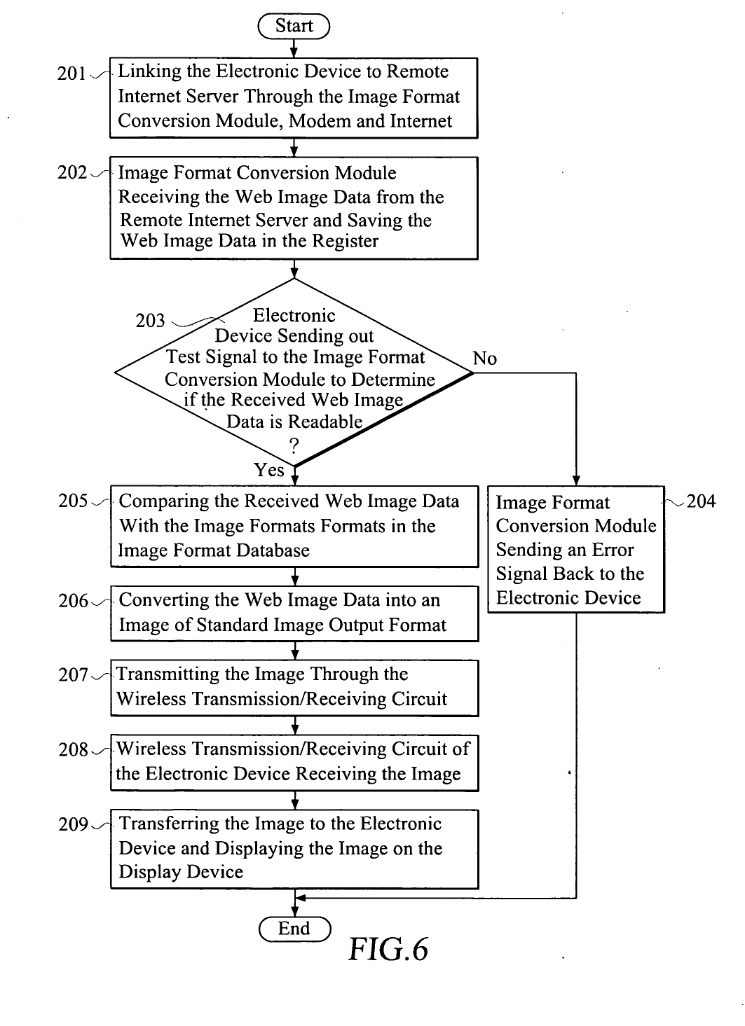

Referring to FIG. 6, a flow chart of the method for converting and displaying web image data of different formats on a display device of an electronic device in accordance with the second embodiment of the present invention is shown. As shown, when a user wants to see a web image from the remote internet server 4 at a selected web site in the internet, the electronic device 5 uses the image format conversion module 1, the modem 2, and the internet 3 to link up to the remote internet server 4 (step 201). The image format conversion module 1 receives web image data from the remote internet server 4 and saves the web image data in the register 13 (step 202).

The electronic device 5 sends out a test signal s1 to the image format conversion module 1 to determine whether the web image data received from the remote internet server 4 at the selected web site is of a format belonging to the plurality of image formats 121, 122, . . . , 125 predefined in the image format conversion module 1 and further determining whether the received web image data is readable (step 203).

If the received web image data is unreadable, the image format conversion module 1 feeds an error signal s2 back to the electronic device 5, to inform the user that the web image from the remote internet server 4 at the selected web site is unreadable (step 204).

If the received web image data is readable, the received web image data is compared with the image formats 121, 122, . . . , 125 defined in the image format database 12 (step 205), and converts the received web image data into an image of the standard image output format (step 206).

The image that is converted to the standard image output format is then transmitted through the wireless transmission/receiving circuit 15 (step 207) and received by the wireless transmission/receiving circuit 53 of the electronic device 5 (step 208). The image of the standard image output format 126, which is received by the wireless transmission/receiving circuit 53, is transferred to the image display control unit 51 displayed on the display device 52 (step 209), to allow the user to observe the web image data from the remote internet server 4 at the selected web site.

In actual implementation, the image formats 121, 122, . . . , 125 defined in the image format database 12 of the image format conversion module 1 might be any type of known image formats, such as jpg file, pdf file, tif file and etc. The standard image output format 126 can be defined according to the field in which the application is used. The electronic device 5 can be a TV set, a PDA, a cell phone and etc.

Although the present in has been described with the reference to the preferred embodiments thereof and the best mode for carrying out the invention, it is apparent to those skilled in the art that a variety of modifications and changes may be made without departing from the scope of the present invention which is intended to be defined by the appended claims.

What is claimed is:

1. A device for converting a web image data of different formats, comprising an image format conversion module connected to an internet for receiving the web image data of different formats transmitted through the internet and converting the web image data into an image of a standard image output format recognizable by an electronic device and displaying said image on a display device of the electronic device, the image format conversion module comprising:
an image format database, which stores a plurality of pre-defined image formats and the standard image output format;
an image processing unit, which receives the web image data from a remote internet server through the internet, matches the received web image data with the image formats stored in the image format database, and converts the received image data into the standard image output format; and
a standard image output format interface, which is connected to the image processing unit and transfers the image that is converted to the standard image output format to the electronic device.

2. The device as claimed in claim 1, wherein the image format conversion module comprises a register, which is connected to the image processing unit for saving the web image data received by the image processing unit.

3. The device as claimed in claim 1, wherein the standard image output format interface of the image format conversion module is connected to a first wireless transmission/receiving circuit and wherein the electronic device comprises a second wireless transmission/receiving circuit for carrying out image data and signal transmission between the electronic device and the image format conversion module.

4. A method for converting and displaying a web image data of different formats on a display device of an electronic device by employing an image format conversion module connected to an internet to convert and display the web image data of different formats received from the internet on the display device of the electronic device, the image format conversion module comprising an image format database storing a plurality of image formats and a standard image output format, the method comprising the following steps:
(a) linking the electronic device to a remote internet server at a predetermined web site through the image format conversion module and the internet;
(b) receiving web image data from the remote internet server by the image format conversion module;
(c) matching the received web image data with image formats stored in the image format database;
(d) converting the received web image data into an image of the standard image output format; and
(e) transferring the image of the standard image output format to the electronic device and displaying said image on the display device.

5. The method as claimed in claim 4, wherein after step (b), the electronic device sends out a test signal to the image format conversion module to determine whether the received web image data from the remote internet server at the predetermined web site is of an image format matching one of the image formats defined in the image format database and to further determine whether the received web image data is readable.

6. The method as claimed in claim 5, wherein when the web image data received from the remote internet server at the predetermined web site is determined to be unreadable, the image format conversion module issues an error signal back to the electronic device to inform a user that the web image data received from the remote internet server at the predetermined web site is unreadable.

7. The method as claimed in claim 4, wherein when the image format conversion module, after receiving web image data from the remote internet server, stores the web image data in a register.
